(19) United States
(12) Patent Application Publication
(10) Pub. No.: US 2010/0321691 A1
(43) Pub. Date: Dec. 23, 2010

(54) MOLECULAR ANALYSIS

(76) Inventor: David Gregson, Surrey (GB)

Correspondence Address: FAY SHARPE LLP, 1228 Euclid Avenue, 5th Floor, The Halle Building, Cleveland, OH, 44115, US

(21) Appl. No.: 12/918,100

(22) PCT Filed: Feb. 18, 2008
(86) PCT No.: PCT/GB09/50159

§ 371 Date: Aug. 18, 2010

(30) Foreign Application Priority Data
Feb. 18, 2008 (GB) 08082888.8

(51) Int. Cl. G01J 3/447; G01J 3/28; G01N 21/19

(52) U.S. Cl. 356/327; 356/326

(57) ABSTRACT

A spectrometer for analysing material comprises a light source, a monochromator for selecting a range of wave-lengths from the light source and emitting them as monochromatic light, a chamber for locating a sample, a focusing means for focusing the monochromatic light onto a sample in the chamber, a detector for measuring the monochromatic light after it has interacted with the sample. An independently variable parameter is varied between two values vi and v2, while the detector measures the monochromatic light across a range of is wavelengths, the independent variable having a value or values between v1 and v1+Δv, and Δv being much smaller than the interval between v1 and v2.

This invention relates to molecular analysis, using one or more spectroscopic probes, particularly a circular dichroism spectroscopic probe.

When a sample containing a chiral chromophore is alternately radiated by left circularly polarised left and right circularly polarised light, the left circularly polarised light will be absorbed to a different extent than the right circularly polarised light. Measuring the difference in absorption ΔA between the left and right circularly polarised light as a function of wavelength gives a circular dichroism spectrum which can give information about the sample, for instance the structure of a protein. Of particular interest is how the structure of the protein changes with temperature, since the integrity of a protein's secondary structure gives a good indication of how stable it will be in solution. In this case, equal amounts of left and right circularly polarised light of a particular wavelength are directed at a sample and the temperature is changed continuously during the measurement. In this way, temperature-induced change in the protein secondary structure may be observed. However, choosing an appropriate wavelength for the measurement assumes a-priori knowledge of the protein, which is not always the case.

Alternatively, one can take a series of measurements on discrete samples for a sequence of wavelengths; but for irreversible denaturation (quite usual), measuring sequentially at more than one wavelength requires a new sample of the protein for each experiment and it may be in short supply. Then, the interpretation of the data is problematic because it is likely to be dependent on a very limited subset of the possible data. The complete measurement process for a sample is also relatively slow compared to other techniques.

The object of the present invention is to provide a fast and convenient method of obtaining and analysing circular dichroism spectra.

Accordingly to the present invention there is provided a spectrometer for analysing material comprising

a light source

a monochromator for selecting a range of wavelengths from the light source and emitting them as monochromatic light

a chamber for locating a sample

a focusing means for focusing the monochromatic light onto a is sample in the chamber

a detector for measuring the monochromatic light after it has interacted with the sample

wherein an independently variable parameter is varied between two values v1 and v2

and the detector measures the monochromatic light across a range of wavelengths when the independent variable has a value or values between v1 and v1+Δv, where Δv is much smaller than the interval between v1 and v2.

According to another aspect of the present invention, there is provided a spectrometer for analysing material comprising

a light source

a monochromator for selecting a range of wavelengths from the light source and emitting them as monochromatic light

a chamber for locating a sample

a focusing means for focusing the monochromatic light onto a sample in the chamber

a detector for measuring the monochromatic light after it has interacted with the sample

wherein the detector is an avalanche photodiode detector.

Recording the CD spectra in this way combines the desirable characteristics of speed and multiple wavelengths and assumes no a-priori knowledge of the protein. It is likely that more data points can be measured, which makes the process of analysing the protein structure with temperature change more accurate and precise.

In particular it makes the calculation of melting points and enthalpies of is transitions very much faster and more robust; it confirms that the protein is correctly folded initially; it identifies the components of the secondary structure that change; and it differentiates between unfolding (where a protein molecule changes its three-dimensional structure) and aggregation (where protein molecules come together in clumps). This allows an estimation of the protein's stability to be made, a confirmation that the sample is the correct, active, protein, and the unfolding behaviour gives chemists guidance as to formulation.

The use of the Wollaston prism arrangement in the monochromator, giving improved light bandwidth, and the use of an avalanche photodiode detector, giving improved signal-to-noise characteristics, both help improve the rate at which readings can be taken across a range of wavelengths while the sample has a particular variable held constant or allowed to move through a small interval, so that the spectrometer can assess a useful number of samples in a practical time scale.

The invention will now be described, by way of example, and with reference to the accompanying drawings, of which:

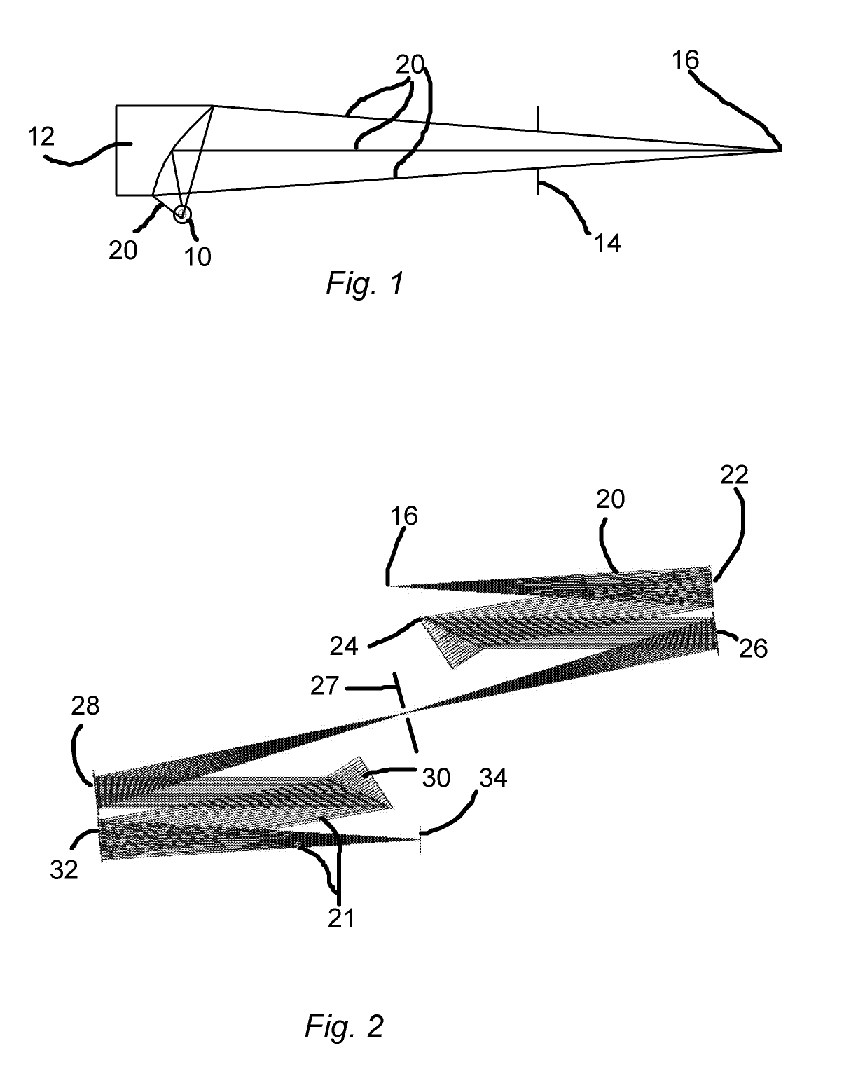

FIG. 1 is a schematic view of the lamp housing;

FIG. 2 is a schematic view of the monochromator;

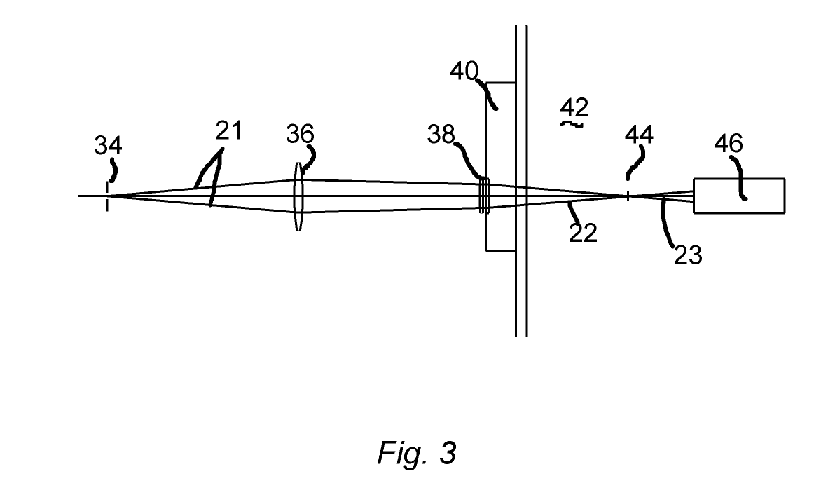

FIG. 3 is a schematic view of the light conditioning unit and the sample chamber;

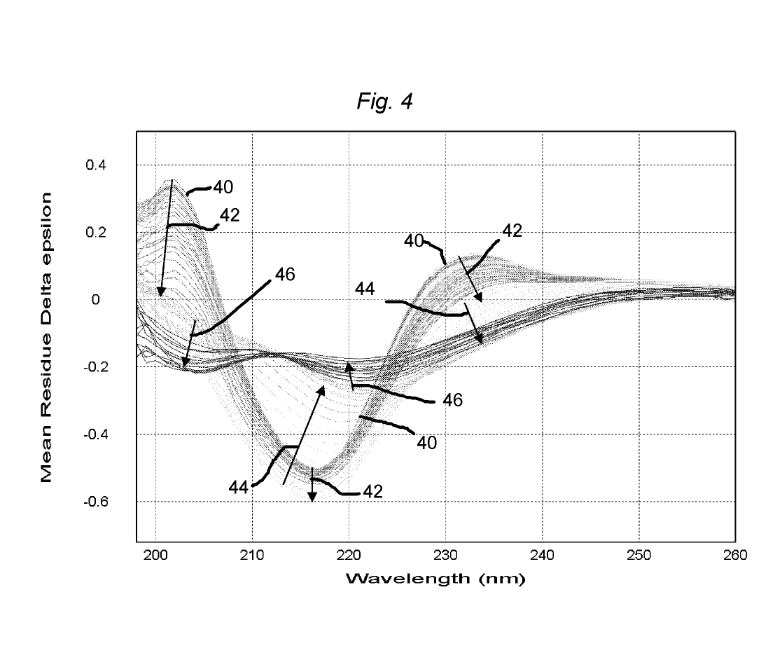

FIG. 4 is a graphical representation of circular dichroism spectra of is a sample;

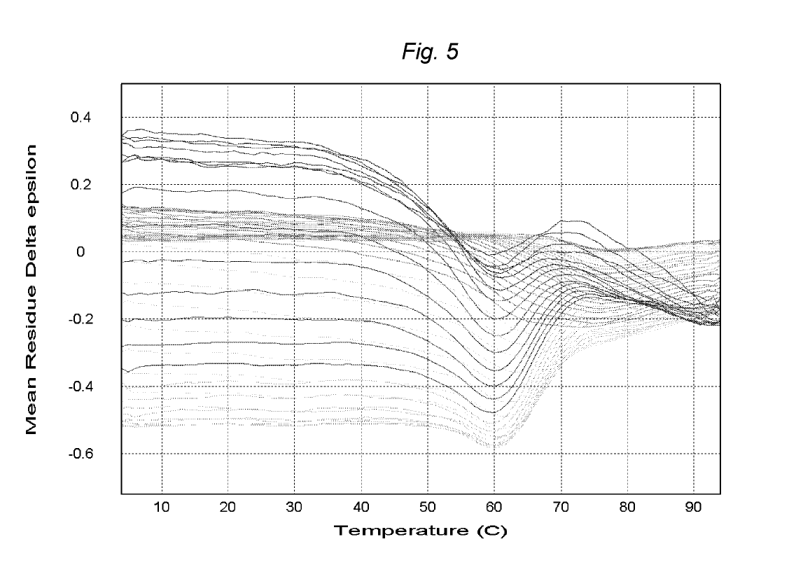

FIG. 5 is a graphical representation of the difference in circular dichroism vs temperature of a sample;

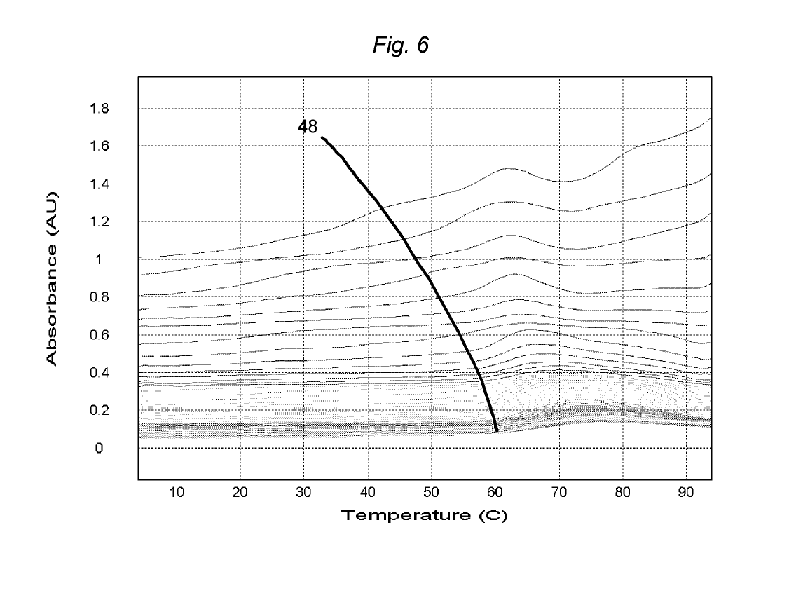

FIG. 6 is a graphical representation of the light absorbance vs temperature of a sample;

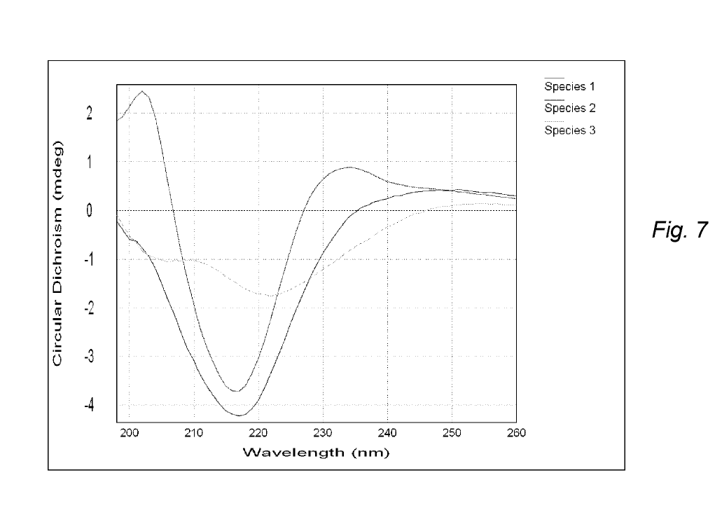

FIG. 7 is a graphical representation of the circular dichroism spectra of the independent species of a sample;

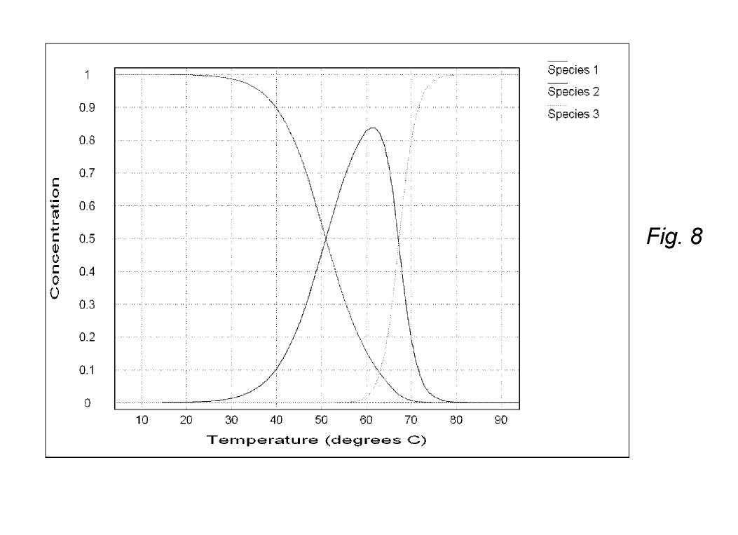

FIG. 8 is a graphical representation of the concentration of the independent species as a function of temperature;

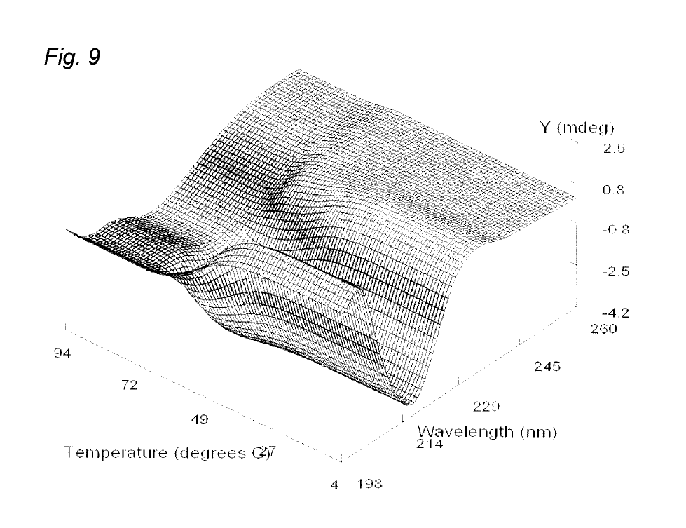

FIG. 9 is a graphical representation of the transition surface for the three independent species together as a function of temperature wavelength and CD difference;

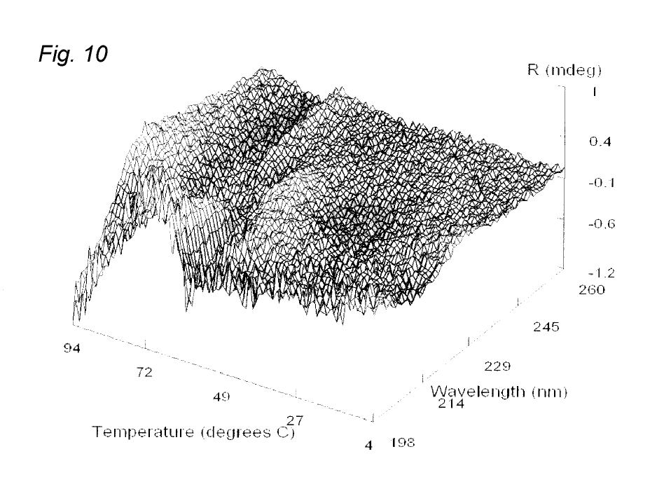

FIG. 10 is a graphical representation of the transition surface for the residue together as a function of temperature wavelength and CD difference.

Referring to FIG. 1, white light (whose path is generally indicated by a middle line and two outer lines 20) is produced from an intense light source 10 chosen to have a good output throughout the ultra-violet region of the spectrum down to approximately 180 nm, such as a xenon arc lamp with a pure silica envelope. This light is focused by a concave reflector, such as an ellipsoidal mirror, 12 through a aperture 14 into the entrance 16 to a is polarising monochromator.

Referring to FIG. 2, the light 20 passes through the entrance slit 16 of the polarising monochromator and falls on a mirror 22 which reflects the light onto a first prism 24. The prism disperses and polarises the light so that diverging ordinary and extraordinary beams of linearly polarised light comprising a limited band of wavelengths fall on a second mirror 26. (For clarity, only one polarisation state is shown post-mirror 26.) Part of the beams pass through the slit 27, which selects for wavelength (because the light is dispersed) and polarisation state (because the polarised beams are divergent). The selection process means that a relatively monochromatic ordinary beam centred about one wavelength and a relatively monochromatic extraordinary beam centred about a slightly different wavelength pass through and fall on a third mirror 28 that reflects the beams onto a second prism 30. The second prism further disperses the light and further separates the ordinary and extraordinary beams, which are reflected via a fourth mirror 32 towards a slit 34. The slit selects only one of the polarised states and defines the final band-pass of the light. The prisms 24, 30 are of a Wollaston prism arrangement, and effectively double the separation of ordinary and extraordinary polarised beams compared to a single polarising Rochon design, enabling twice the bandwidth to be selected. The monochromator is arranged to maximise the light output.

The wavelength of light leaving the monochromator may be varied through control means which adjust the prisms in the monochromator. The beam of light leaving the polarising monochromator for the present application ideally comprises a series of ultra-violet wavelengths from the range 180 nm and 260 nm, though of course the particular range may be chosen to suit a particular application.

Referring to FIG. 3, the linearly polarised, monochromatic light 21 emerging from the polarising monochromator exit slit 34 is focused by lenses 36, 38 onto a photo-elastic modulator (PEM), which converts at high frequency the linearly polarised light into alternately left- and right-circularly polarised light 22. The alternately polarised light 22 irradiates a sample placed in sample chamber 42.

Light of a particular wavelength may be absorbed by the sample, and in the case of a molecule containing one or more chiral chromophores, such as a protein, the absorption may be different for left- and right-circularly polarised light.

The sample is a contained in a suitable cell, which includes a thermocouple and peltier device by which means the temperature of the cell is precisely and rapidly controlled.

A detector 46 placed after the sample detects how much left- and right-circularly polarised light is transmitted through the sample at each wavelength, from which the difference in their absorption, i.e. the circular dichroism, can be determined. The set of data gives a ΔA surface, that is, a series of spectra as a function of temperature. The detector uses an avalanche photodiode detector in order to maximise the signal to noise ratio.

As light is directed on to the sample and readings at different wavelengths are taken, the sample temperature is continuously increased. A typical is heating regime may start at 4° C. and be raised at 1° C. per minute until the temperature reaches 95° C. In this way, a set of data is generated that gives a CD surface, where each point on the surface is characterised by a value of CD corresponding to a precise wavelength and a precise temperature.

Referring to FIG. 4, the CD surface is projected onto the CD-wavelength plane, with each CD spectrum, taken at intervals of 1° C., represented by a single line. The CD spectrum 40, measured at the beginning of the experiment, has a shape that is typical of a well-folded protein of the type under investigation. This is a positive indicator that the protein is biologically active. As the temperature increases, there is little change between 4° C. and 40° C.; between approximately 40° C. and 60° C., the secondary structure changes significantly, as shown by the progression of CD spectra indicated by arrows 42. Between approximately 60° C. and 75° C., a second change in secondary structure occurs, as shown by the progression of CD spectra indicated by arrows 44. A further change in the secondary structure of the protein takes place between 75° C. and 90° C. as shown by the progression of the CD spectra indicated by the arrows 46.

Referring to FIG. 5, the CD surface is projected onto the CD-temperature plane with each trace representing a CD-temperature profile at a given wavelength. Two transitions between secondary structures can be seen clearly, having mid-points around 50° C. and 65° C., and possibly a third transition having a mid-point above 75° C.

The absorbance of the sample can be derived accurately and in real-time from the CD data. Referring to FIG. 6, the absorbance surface is projected onto the absorbance-temperature plane with each trace representing an absorbance-temperature profile at a given wavelength. At wavelengths is where there is no chromophore and thus no possible true absorbance, e.g. trace 48, a change in the apparent absorbance commencing at about 60° C. can be seen nonetheless. The change is due to light scattering and absorbance is used as a proxy to monitor it. Light is scattered by particles formed during aggregation. The aggregating particles reach such a size that they eventually precipitate and this can be seen in trace 48 and others as the absorbance profile decreases from approximately 73° C. onwards.

The analysis of the data may be completely automated but typically is done in a number of steps. Using singular value decomposition or similar techniques, the principal components in the data can be identified. The principal components define the number of states present and therefore an appropriate model for the data can be identified. For example, a two-state reversible transition can be modelled using the appropriate thermodynamic equations for a reversible two-state system. Using non-linear least-squares or similar techniques, the model can be refined to give a best fit to the data. The model is used to calculate the mid-point temperature and enthalpy for each transition, the spectra of the initial, final and any intermediate states (shown for the present example in FIG. 7), and the concentration profiles s of the states as a function of temperature (shown for the present example in FIG. 8).

One can also calculate the transition surface for the three independent species together as a function of temperature wavelength and CD difference (FIG. 9) which gives a three dimensional surface. The residual surface (i.e. the data which remains after the calculated effect of the three independent species have been subtracted from the original data), may also be plotted in this way as shown in FIG. 10, which in this example seems to show a non-random fourth species.

With the optical arrangement in the monochromator and the detection system described herein, it is possible to analyse many samples a day. The presentation of samples may be automated.

The same principle may be used when analysing a sample using other techniques, such as measuring the fluorescence. Further, rather than varying the temperature with the optical quantity being measured, another independent variable, such as pH or sample concentration, could be changed whilst the optical quantity is being measured.

1. A spectrometer for analysing material, comprising:
a light source;
monochromator for selecting a range of wavelengths from the light source and emitting them as monochromatic light;
a chamber for locating a sample;
a focusing means for focusing the monochromatic light onto a sample in the chamber;
a detector for measuring the monochromatic light after it has interacted with the sample;
wherein an independently variable parameter is varied between two values v1 and v2; and
wherein the detector measures the monochromatic light across a range of wavelengths when the independent variable has a value or values between v1 and v1+Δv, where Δv is much smaller than the interval between v1 and v2.

2. A spectrometer according to claim 1, including a polarising means that polarises the light into separate right and left circularly polarised light.

3. A spectrometer according to claim 1, wherein the detector is an avalanche photodiode detector.

4. A spectrometer according to claim 1, wherein the property of the sample which is varied is temperature.

5. A spectrometer according to claim 1, wherein the property of the sample which is varied is pH.

6. A spectrometer according to claim 1, wherein there is included software that accepts the data from the detector to determine values of the parameters which are varied at which a transition in the sample occurs.

7. A spectrometer according to claim 4, including software that accepts the data from the detector to determine value of the enthalpy or other thermodynamic property of the sample that occurs during a transition.

8. A spectrometer for analysing material comprising;
a light source;
a monochromator for selecting a range of wavelengths from the light source and emitting them as monochromatic light;
a chamber for locating a sample;
a focusing means for focusing the monochromatic light onto a sample in the chamber; and
a detector for measuring the monochromatic light after it has interacted with the sample;
wherein the detector is an avalanche photodiode detector.

9. A spectrometer according to claim 8, wherein a property of the sample is varied between two values v1 and v2, and wherein the detector measures the monochromatic light across a range of wavelengths when the sample has a value or values between v1 and v1+Δv, where Δv is much smaller than the interval between v1 and v2.

10. A spectrometer according to claim 8, wherein there is included a polarising means that polarises the light into separate right and left circularly polarised light.

11. A spectrometer according to claim 8, wherein the property of the sample which is varied is temperature.

12. A spectrometer according to claim 8, wherein the property of the sample which is varied is pH.

13. A spectrometer according to claim 8, wherein there is included software that accepts the data from the detector to determine value of the parameters which are varied at which a transition in the sample occurs.

14. A spectrometer according to claim 8, wherein there is included software that accepts the data from the detector to determine value of the enthalpy or other thermodynamic property of the sample that occurs during a transition.
